(19) United States
(12) Patent Application Publication
(10) Pub. No.: US 2021/0341501 A1
(43) Pub. Date: Nov. 4, 2021

(54) AUTOMATIC ANALYZING APPARATUS

(71) Applicant: Canon Medical Systems Corporation, Otawara-shi (JP)

(72) Inventor: Shin IIDA, Tokyo (JP)

(73) Assignee: Canon Medical Systems Corporation, Otawara-shi (JP)

(21) Appl. No.: 17/243,642

(22) Filed: Apr. 29, 2021

(30) Foreign Application Priority Data
May 1, 2020 (JP) 2020-081231

(51) Int. Cl. G01N 35/00; G01N 35/10

(52) U.S. Cl. CPC G01N 35/00584; G01N 2035/1027; G01N 35/1002

(57) ABSTRACT

According to one embodiment, an automatic analyzing apparatus includes a dispenser, a rod, and control circuitry. The dispenser supplies at least one of a reagent and a specimen. The rod adheres at least one of the reagent and the specimen supplied from the dispenser. The control circuitry inserts the rod to which said at least one of the reagent and the specimen is adhered into a liquid contained in a vessel.

### CROSS-REFERENCE TO RELATED APPLICATIONS

This application is based upon and claims the benefit of priority from Japanese Patent Application No. 2020-081231, filed May 1, 2020, the entire contents of which are incorporated herein by reference.

### FIELD

Embodiments described herein relate generally to an automatic analyzing apparatus.

### BACKGROUND

Conventionally, a micro-dispense technique in which a dispense amount of a biological specimen (hereinafter referred to as a “specimen”) such as blood or urine or a dispense amount of a reagent solution is reduced in an automatic analyzing apparatus for clinical examination has been known. Through the micro-dispense technique, the automatic analyzing apparatus is capable of ensuring the precision of the dispense amount up to a certain amount. On the other hand, when a micro amount of a specimen and a reagent solution are mixed and stirred, for example, there is a concern that the stirring may be insufficient.

### BRIEF DESCRIPTION OF THE DRAWINGS

FIG. 1 is a block diagram showing a configuration example of an automatic analyzing apparatus according to a first embodiment.

FIG. 2 is a perspective view illustrating a configuration of an analysis mechanism according to the first embodiment.

FIG. 3 is a flowchart illustrating an operation of the analysis mechanism according to the first embodiment.

FIG. 4 is a schematic view of the analysis mechanism according to the first embodiment as viewed from above.

FIG. 5 is a flowchart illustrating an operation of a pinpoint dispense unit according to the first embodiment.

FIG. 6 is a schematic diagram illustrating an operation of a pinpoint dispense unit according to the first embodiment.

FIG. 7 is a schematic diagram illustrating an operation of a pinpoint dispense unit according to the first embodiment.

FIG. 8 is a schematic diagram illustrating an operation of a pinpoint dispense unit according to the first embodiment.

FIG. 9 is a schematic diagram illustrating an operation of a pinpoint dispense unit according to the first embodiment.

FIG. 10 is a schematic diagram illustrating an operation of a pinpoint dispense unit according to the first embodiment.

FIG. 11 is a schematic diagram illustrating an operation of a pinpoint dispense unit according to the first embodiment.

FIG. 12 is a schematic diagram illustrating an operation of a pinpoint dispense unit according to the first embodiment.

FIG. 13 is a schematic diagram illustrating an operation of a pinpoint dispense unit according to the first embodiment.

FIG. 14 is a schematic diagram illustrating an operation of a pinpoint dispense unit according to the first embodiment.

FIG. 15 is a schematic diagram illustrating an operation of a pinpoint dispense unit according to the first embodiment.

FIG. 16 is a schematic diagram illustrating an operation of a pinpoint dispense unit according to the first embodiment.

FIG. 17 is a schematic diagram illustrating an operation of a pinpoint dispense unit according to the first embodiment.

FIG. 18 is a perspective view illustrating a configuration of an analysis mechanism according to a second embodiment.

FIG. 19 is a flowchart illustrating an operation of the analysis mechanism according to the second embodiment.

FIG. 20 is a schematic view of the analysis mechanism according to the second embodiment as viewed from above.

FIG. 21 is a flowchart illustrating an operation of a pinpoint dispense unit according to the second embodiment.

FIG. 22 is a schematic diagram illustrating an operation of a pinpoint dispense unit according to the second embodiment.

FIG. 23 is a schematic diagram illustrating an operation of a pinpoint dispense unit according to the second embodiment.

FIG. 24 is a schematic diagram illustrating an operation of a pinpoint dispense unit according to the second embodiment.

FIG. 25 is a schematic diagram illustrating an operation of a pinpoint dispense unit according to the second embodiment.

FIG. 26 is a schematic diagram illustrating an operation of a pinpoint dispense unit according to the second embodiment.

FIG. 27 is a perspective view illustrating a configuration of an analysis mechanism according to a third embodiment.

FIG. 28 is a flowchart illustrating an operation of the analysis mechanism according to the third embodiment.

FIG. 29 is a schematic view of the analysis mechanism according to the third embodiment as viewed from above.

FIG. 30 is a flowchart illustrating an operation of a pinpoint dispense unit according to the third embodiment.

FIG. 31 is a schematic diagram illustrating an operation of a pinpoint dispense unit according to the third embodiment.

### DETAILED DESCRIPTION

In general, according to one embodiment, an automatic analyzing apparatus includes a dispenser, a rod, and control circuitry. The dispenser supplies at least one of a reagent and a specimen. The rod adheres at least one of the reagent and the specimen supplied from the dispenser. The control circuitry inserts the rod to which said at least one of the reagent and the specimen is adhered into a liquid contained in a vessel.

Embodiments of an automatic analyzing apparatus will now be described in detail with reference to the accompanying drawings.

### First Embodiment

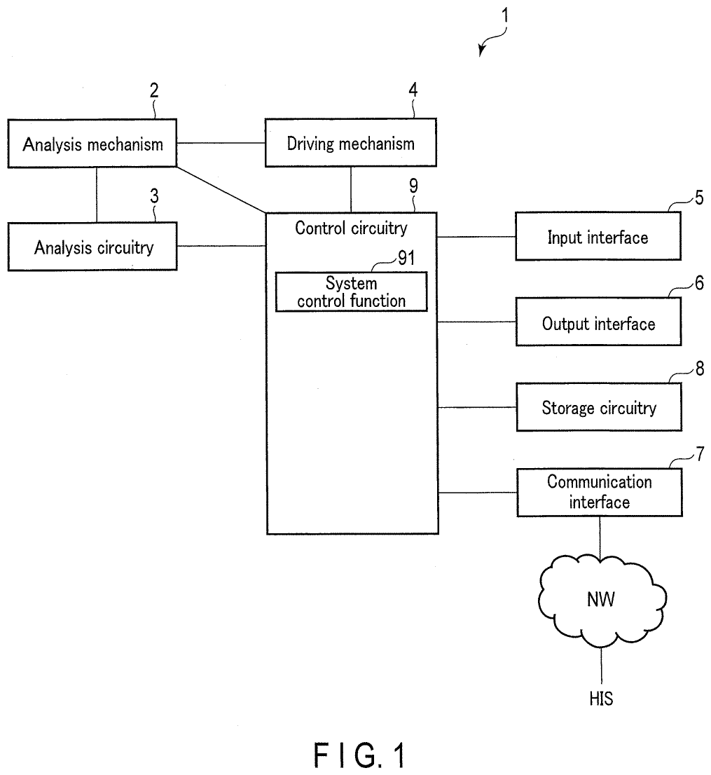

FIG. 1 is a diagram showing a configuration example of an automatic analyzing apparatus according to a first embodiment. As shown in FIG. 1, for example, an automatic analyzing apparatus 1 according to the first embodiment includes an analysis mechanism 2, analysis circuitry 3, a driving mechanism 4, an input interface 5, an output interface 6, a communication interface 7, storage circuitry 8, and control circuitry 9.

The analysis mechanism 2 mixes a specimen such as blood, urine, or the like with a reagent solution used in each inspection item. Depending on the inspection item, the analysis mechanism 2 mixes a standard solution diluted at a predetermined magnification with a reagent solution used for the inspection item. The analysis mechanism 2 measures optical property values of the mixed solution of the specimen or the standard solution and the reagent solution. By this measurement, standard data and inspection target data represented by, for example, the transmitted light intensity or absorbance, the scattered light intensity, etc. are generated.

The analysis circuitry 3 is a processor configured to generate calibration data and analysis data by analyzing the standard data and the inspection target data generated by the analysis mechanism 2. The analysis circuitry 3 reads an analysis program from the storage circuitry 8, for example, and analyzes the standard data and the inspection target data in accordance with the read analysis program. The analysis circuitry 3 may include a storage area that stores at least part of data stored in the storage circuitry 8.

The driving mechanism 4 drives the analysis mechanism 2 under the control of the control circuitry 9. The driving mechanism 4 is implemented by, for example, a gear, a stepping motor, a belt conveyor, and a lead screw.

The input interface 5 accepts, for example, setting of analysis parameters and the like for each inspection item regarding a specimen for which a measurement instruction has been made by the operator, or a specimen for which a measurement request has been made via an in-hospital network NW. The input interface 5 is implemented by, for example, a mouse, a keyboard, a touch pad to which an instruction is input via a touch on its operation surface, a touch panel, or the like. The input interface 5 is connected to the control circuitry 9, converts an operation instruction input by the operator into an electrical signal, and outputs the electrical signal to the control circuitry 9.

Herein, the input interface 5 is not limited to one that has physical operational components such as a mouse, a keyboard, etc. The input interface 5 may include, for example, an electrical signal processing circuit which receives an electrical signal corresponding to an operation instruction input from an external input device disposed separately from the automatic analyzing apparatus 1 and outputs the received electrical signal to the control circuitry 9.

The output interface 6 is connected to the control circuitry 9, and outputs the signal supplied from the control circuitry 9. The output interface 6 is implemented by, for example, display circuitry, printing circuitry, an audio device, or the like.

The display circuitry includes, for example, a cathode-ray tube (CRT) display, a liquid crystal display, an organic electroluminescence (EL) display, a light-emitting diode (LED) display, a plasma display, or the like. The display circuitry may include processing circuitry which converts data representing a target of display into a video signal, and outputs the video signal to the outside. The printing circuitry includes, for example, a printer. The printing circuitry may include output circuitry which outputs data representing a target of printing to the outside. The audio device includes, for example, a speaker. The audio device may include output circuitry which outputs an audio signal to the outside. The output interface 6 may be implemented as a touch panel or a touch screen together with the input interface 5.

The communication interface 7 connects to, for example, the in-hospital network NW. The communication interface 7 performs data communications with a hospital information system (HIS) via the in-hospital network NW.

The communication interface 7 may perform data communications with the HIS via a laboratory information system (LIS) connected to the in-hospital network NW.

The storage circuitry 8 includes a processor-readable storage medium such as a magnetic storage medium, an optical storage medium, or a semiconductor memory. The storage circuitry 8 need not necessarily be implemented by a single storage device. For example, the storage circuitry 8 may be implemented by a plurality of storage devices. The storage circuitry 8 stores an analysis program to be executed by the analysis circuitry 3, and a control program for implementing the function of the control circuitry 9. The storage circuitry 8 stores calibration data generated by the analysis circuitry 3 for each inspection item. The storage circuitry 8 stores analysis data generated by the analysis circuitry 3 for each specimen. The storage circuitry 8 stores an inspection order input from an operator, or an inspection order received by the communication interface 7 via the in-hospital network NW.

The control circuitry 9 is a processor that functions as, for example, the nerve center of the automatic analyzing apparatus 1. The control circuitry 9 executes a program stored in the storage circuitry 8, and thereby implements the function corresponding to the executed program. The control circuitry 9 may include a storage area that stores at least part of data stored in the storage circuitry 8.

The control circuitry 9 includes a system control function 91 that is implemented by, for example, executing an operation program. In the present embodiment, a case will be described where the system control function 91 is implemented by a single processor; however, the configuration is not limited thereto. For example, control circuitry may be configured by combining a plurality of independent processors that execute respective operation programs, thereby implementing the system control function 91.

The system control function 91 is a function of collectively controlling the units in the automatic analyzing apparatus 1 based on input information input from the input interface 5. With the system control function 91, the control circuitry 9 drives the driving mechanism 4 to perform measurements according to the inspection item, and controls the analysis circuitry 3 to analyze the standard data and the inspection target data generated by the analysis mechanism 2.

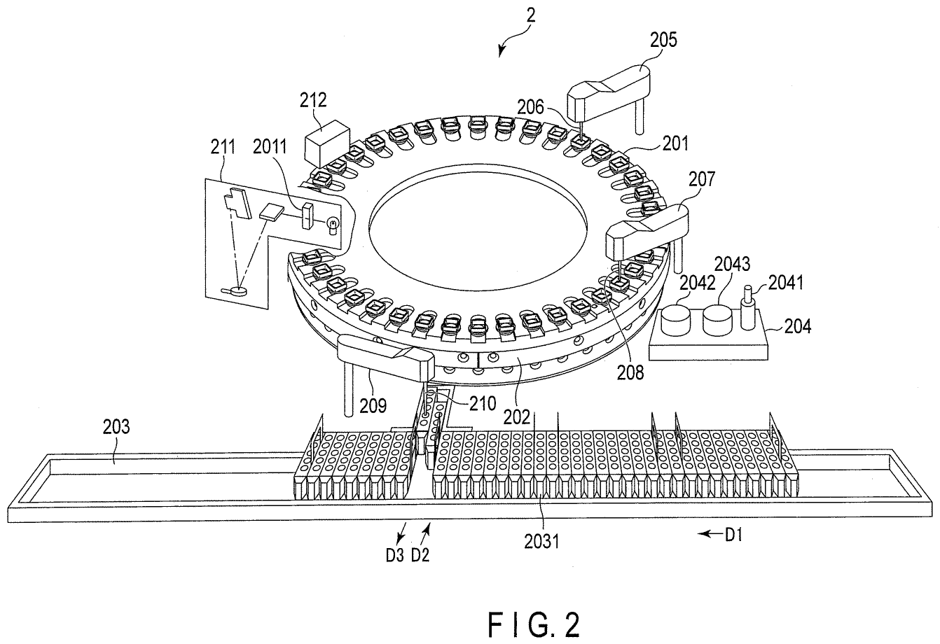

FIG. 2 is a perspective view illustrating a configuration of an analysis mechanism according to the first embodiment. As shown in FIG. 2, for example, the analysis mechanism 2 according to the first embodiment includes a reaction disk 201, a thermostatic portion 202, a rack sampler 203, and a pinpoint dispense unit 204.

The reaction disk 201 holds a plurality of reaction vessels 2011 in an annularly arrayed manner. The reaction disk 201 conveys the reaction vessels 2011 along a predetermined path. Specifically, the reaction disk 201 conveys the reaction vessels 2011 by, for example, causing the driving mechanism 4 to alternately repeat pivot and stop at a predetermined time interval. The reaction vessels may be referred to as cuvettes.

The thermostatic portion 202 retains a heating medium set at a predetermined temperature, and dips the reaction vessel 2011 into the heating medium retained therein, thus heating up a mixed solution contained in the reaction vessel 2011.

The rack sampler 203 movably supports a plurality of specimen racks 2031 each capable of holding a plurality of specimen vessels that contain a specimen for which a measurement request has been made. In the example shown in FIG. 2, a plurality of specimen racks 2031 each capable of holding five specimen vessels in parallel are shown.

In the rack sampler 203, a conveying region in which a specimen rack 2031 is conveyed from an injection position at which the specimen rack 2031 is injected to a withdrawal position to which the specimen rack 2031 for which the measurement has been completed is withdrawn is disposed. In the conveying region, a plurality of specimen racks 2031 aligned in a longitudinal direction are moved in a direction D1 by the driving mechanism 4.

In the rack sampler 203, a pull-in region in which the specimen rack 2031 is pulled in from the conveying region is disposed, to move the specimen vessel stored in the specimen rack 2031 to a predetermined sample aspiration position. The sample aspiration position is disposed at, for example, the position where the pivot track of the sample dispense probe 210 and the movement track of the opening of the specimen vessel supported by the rack sampler 203 and held by the specimen rack 2031 intersect each other. In the pull-in region, a specimen rack 2031 that has been conveyed is moved in a direction D2 by the driving mechanism 4.

In the rack sampler 203, a return region for returning the specimen rack 2031 which holds specimen vessels that have aspirated a specimen back to the conveying region is disposed. In the return region, the specimen rack 2031 is moved in a direction D3 by the driving mechanism 4.

The pinpoint dispense unit 204 keeps cold a plurality of reagent vessels (not illustrated) that contain a concentration reagent and the like used in each item of inspection to be performed on a standard solution and a specimen. The concentration reagent becomes a reagent solution by being diluted by a diluent, etc. The pinpoint dispense unit 204 includes a reagent dispenser 2041, a washing tank 2042, and a drying tank 2043.

The reagent dispenser 2041 dispenses a concentration reagent to a stirring rod 208 (to be described later). The dispensing method may be of, for example, either a non-contact type or a contact type. In the non-contact type, a concentration reagent is provided to the stirring rod 208 arranged above the reagent dispenser 2041. In the contact type, a concentration reagent is adhered or dispensed to a distal end of a needle disposed at the reagent dispenser 2041, to be brought into contact with the stirring rod 208. As a specific example, in the reagent dispenser 2041 of the contact type, a needle penetrates through a concentration reagent held within the tube by surface tension, and a very small amount of concentration reagent adhered to the end of the needle after the penetration is brought into contact with the stirring rod 208. As another specific example, in the reagent dispenser 2041 of the contact type, a concentration reagent that has passed through the interior of a tubular needle is dispensed to the end of the needle, and a very small amount of concentration reagent held at the end of the needle is brought into contact with the stirring rod 208. Regardless of whether the dispensing method is the non-contact type or the contact type, dispensing a micro amount of a concentration reagent to the stirring rod 208 will be referred to as “pinpoint dispensing”. In the present embodiment, a description will be given of a contact-type needle dispenser. The “reagent dispenser” in the present embodiment, which provides a concentration reagent, may be simply referred to as a “dispenser”.

FIG. 2 illustrates a case where the reagent dispenser 2041 supplies a concentration reagent in a vertically upward direction; however, the configuration is not limited thereto. For example, the reagent dispenser 2041 may supply a concentration reagent in a lateral direction so as to dispense a concentration reagent to the side surface of the stirring rod 208. Alternatively, the reagent dispenser 2041 may supply a concentration reagent in a vertically downward direction so as to dispense a concentration reagent to the stirring rod 208 from above the stirring rod 208. That is, the reagent dispenser 2041 may have any configuration that is capable of pinpoint-dispensing the concentration reagent to the stirring rod 208.

The washing tank 2042 washes the stirring rod 208 subjected to stirring of the reagent solution. The washing tank 2042 may perform, for example, ultrasonic washing using washing water disposed in the tank.

The drying tank 2043 dries the stirring rod 208 subjected to the washing. The drying tank 2043 includes, for example, a fan for generating wind. Specifically, the drying tank 2043 is capable of blowing off droplets adhered to the stirring rod 208 by directing a fan-generated wind to the stirring rod 208 inserted into the tank.

The analysis mechanism 2 shown in FIG. 2 includes a diluent dispense arm 205, a diluent dispense probe 206, a stirring rod arm 207 (also referred to as a “holding mechanism”), a stirring rod 208, a sample dispense arm 209, a sample dispense probe 210, a photometry unit 211, and a stirring unit 212.

The diluent dispense arm 205 is disposed in the vicinity of the reaction disk 201. Specifically, the diluent dispense arm 205 is, for example, disposed between the stirring unit 212 and the stirring rod arm 207 along the rotational direction of the reaction disk 201. The diluent dispense arm 205 holds a diluent dispense probe 206 at one end.

The diluent dispense probe 206 is positioned directly above an opening of the reaction vessel 2011 held by the reaction disk 201. The diluent dispense probe 206 dispenses a diluent to a vacant reaction vessel 2011 under the control of the control circuitry 9, for example. The position above the reaction vessel 2011 that dispenses a diluent is referred to as a “diluent dispense position”.

The stirring rod arm 207 is disposed in the vicinity of the reaction disk 201 and the pinpoint dispense unit 204. The stirring rod arm 207 is disposed, by the driving mechanism 4, to be movable vertically upward and downward, and be horizontally pivotable. The stirring rod arm 207 holds a stirring rod 208 at one end.

The stirring rod 208 is capable of stirring a liquid by rotation or vibration. The stirring rod 208 is formed of a resin such as plastic or metal. As for the shape of the stirring rod, the entire part including an end part may be formed in a substantially unique spatular shape, or the end part may be configured as a propeller-shaped or paddle-shaped stirring blade. The structure of the stirring rod 208 may be varied according to the amount of the reagent to be supplied and its viscosity.

As the stirring rod arm 207 pivots, the stirring rod 208 pivots along an arc-like pivot track. On this pivot track, an opening of the reaction vessel 2011 held by the reaction disk 201, an opening of the washing tank 2042, an opening of the drying tank 2043, and an end of the needle of the reagent dispenser 2041 are positioned. In the first embodiment, they are respectively referred to as a “reagent solution generation position”, a “washing position”, a “drying position”, and a “pinpoint dispense position”.

The stirring rod 208 moves between the reagent solution generation position and the pinpoint dispense position under the control of the control circuitry 9. The stirring rod 208 which has moved to the pinpoint dispense position pinpoint-dispenses the concentration reagent supplied from the reagent dispenser 2041. The stirring rod 208 which has moved to the reagent solution generation position and to which the concentration reagent has been pinpoint-dispensed is inserted into a diluent contained in the reaction vessel 2011 and stirred. Thereby, a reagent solution is generated in the reaction vessel 2011. In the present embodiment, a “stirring rod”, to which a concentration reagent is pinpoint-dispensed, may be simply referred to as a “rod”.

The sample dispense arm 209 is disposed between the reaction disk 201 and the rack sampler 203. The sample dispense arm 209 is disposed, by the driving mechanism 4, to be movable vertically upward and downward, and be horizontally pivotable. The sample dispense arm 209 holds a sample dispense probe 210 at one end.

As the sample dispense arm 209 pivots, the sample dispense probe 210 pivots along an arc-like pivot track. On the pivot track, the opening of the specimen vessel held by the specimen rack 2031 on the rack sampler 203 is positioned. On the pivot track of the sample dispense probe 210, a sample provide position for providing a specimen aspirated by the sample dispense probe 210 to the reaction vessel 2011 is disposed. The sample provide position corresponds to an intersection between the pivot track of the sample dispense probe 210 and the movement track of the reaction vessel 2011 held by the reaction disk 201.

The sample dispense probe 210 is driven by the driving mechanism 4, and moves upward and downward at a position directly above the opening of the specimen vessel held by the specimen rack 2031 on the rack sampler 203, and at the sample provide position. Under the control of the control circuitry 9, the sample dispense probe 210 aspirates a specimen from a specimen vessel positioned directly therebelow. Under the control of the control circuitry 9, the sample dispense probe 210 provides the aspirated specimen to the reaction vessel 2011 positioned directly below the sample provide position.

The photometry unit 211 optically measures predetermined components in a mixed solution of the specimen and the reagent solution provided into the reaction vessel 2011. The photometry unit 211 includes a light source and a photodetector. Under the control of the control circuitry 9, the photometry unit 211 emits light from the light source. The emitted light is made incident on a first side wall of the reaction vessel 2011, and exits from a second side wall opposing the first side wall. The photometry unit 211 detects the light that has exited from the reaction vessel 2011 by the photodetector.

Specifically, the photodetector detects light that has passed through a mixed solution of a standard specimen and a reagent solution in the reaction vessel 2011, and generates standard data represented by the absorbance or the like based on the intensity of the detected light. Also, the photodetector detects light that has passed through a mixed solution of a reagent solution and a specimen to be an inspection target in the reaction vessel 2011, and generates inspection target data represented by the absorbance or the like based on the intensity of the detected light. The photometry unit 211 outputs the generated standard data and the inspection target data to the analysis circuitry 3. The photodetector may be configured to detect scattered light that has been scattered by the mixed solution in the reaction vessel 2011, and may generate standard data and inspection target data represented by the scattered light intensity.

The stirring unit 212 is disposed in the vicinity of the outer periphery of the reaction disk 201. The stirring unit 212 includes a stirring rod. Under the control of the control circuitry 9, the stirring unit 212 stirs a mixed solution of a specimen and a reagent solution contained in the reaction vessel 2011 positioned at a mixed solution stirring position on the reaction disk 201 using a stirring rod.

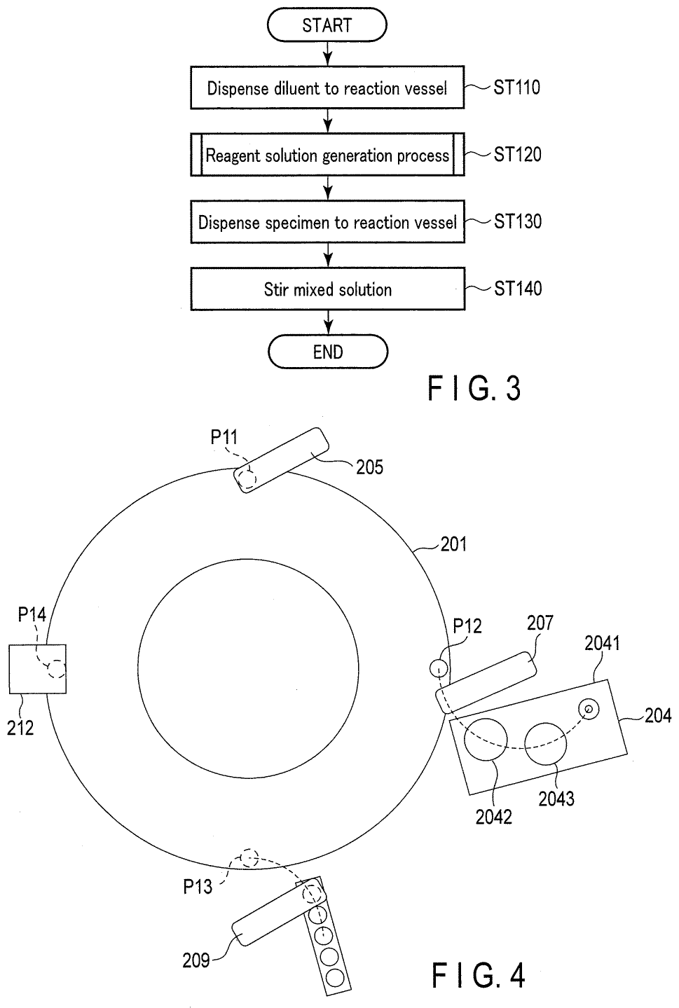

FIG. 3 is a flowchart illustrating an operation of the analysis mechanism according to the first embodiment. Upon activation of the automatic analyzing apparatus 1, for example, the control circuitry 9 reads a control program stored in the storage circuitry 8, and executes a system control function 91. Through the system control function 91, the control circuitry 9 executes a process related to a dispense function during activation of the automatic analyzing apparatus 1.

The concrete operations of the flowchart of FIG. 3 will be described with reference to the schematic view of FIG. 4. FIG. 4 is a schematic view of the analysis mechanism according to the first embodiment as viewed from above.

Hereinafter, the phrases used when the driving mechanism 4 drives each component during an operation of a probe, etc., such as “by the driving mechanism 4” or “driven by the driving mechanism 4”, will be omitted. Also, it is to be noted that the control circuitry 9 controls each component in any of the operations, unless otherwise stated. Such matters similarly apply to the flowcharts that will be described later.

(Step ST110)

The control circuitry 9 causes a diluent to be dispensed to the reaction vessel 2011. Specifically, the reaction disk 201 pivots a vacant reaction vessel 2011 to be moved to a diluent dispense position (position P11) in advance. The diluent dispense probe 206 included in the diluent dispense arm 205 aspirates the diluent and provides the aspirated diluent to the vacant reaction vessel 2011 at the diluent dispense position. After the diluent is dispensed, the reaction disk 201 pivots the reaction vessel 2011 to be moved from a position P11 to a reagent solution generation position (position P12).

(Step ST120)

After the operation at step ST110, the control circuitry 9 executes a reagent solution generation process, thereby generating a reagent solution. The reagent solution generation process will be described later. After the reagent solution is generated, the reaction disk 201 pivots the reaction vessel 2011 to be moved from the reagent solution generation position (position P12) to a sample provide position (position P13).

(Step ST130)

After the operation at step ST120, the control circuitry 9 causes a specimen to be dispensed to the reaction vessel 2011 containing a reagent solution. Specifically, the sample dispense probe 210 aspirates the specimen from the specimen vessel, and provides the aspirated specimen to the reaction vessel 2011 at the sample provide position (position P13). After the specimen is provided, the reaction disk 201 pivots the reaction vessel 2011 to be moved from the position P13 to a mixed solution stirring position (position P14).

(Step ST140)

After the operation at step ST130, the control circuitry 9 causes a mixed solution of a reagent solution and a specimen to be stirred. Specifically, the stirring unit 212 stirs a mixed solution contained in the reaction vessel 2011 at the mixed solution stirring position (position P14) using a stirring rod.

After step ST140, the processing ends. The control circuitry 9 may, for example, repeatedly perform the operations from step ST110 to step ST140, for example, with respect to each of the specimen vessels held by the rack sampler 203.

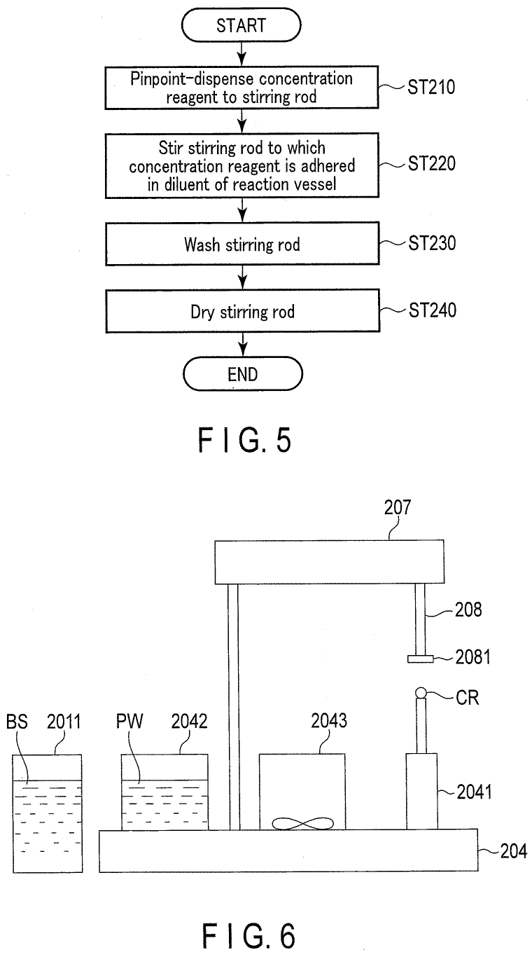

FIG. 5 is a flowchart illustrating an operation of a pinpoint dispense unit according to the first embodiment. In the flowchart of FIG. 5, the reagent solution generation process at step ST120 is included, and step ST210 is executed after step ST110.

The concrete operations of the flowchart of FIG. 5 will be described with reference to the schematic views of FIGS. 6 to 17. FIGS. 6 to 17 are schematic diagrams illustrating operations of a pinpoint dispense unit according to the first embodiment.

(Step ST210)

The control circuitry 9 causes a concentration reagent to be pinpoint-dispensed to the stirring rod 208. Specifically, the stirring rod arm 207 pivots the stirring rod 208 to be positioned directly above the reagent dispenser 2041, as shown in FIG. 6. At this time, a concentration reagent CR is supplied at an end of the needle disposed at the reagent dispenser 2041.

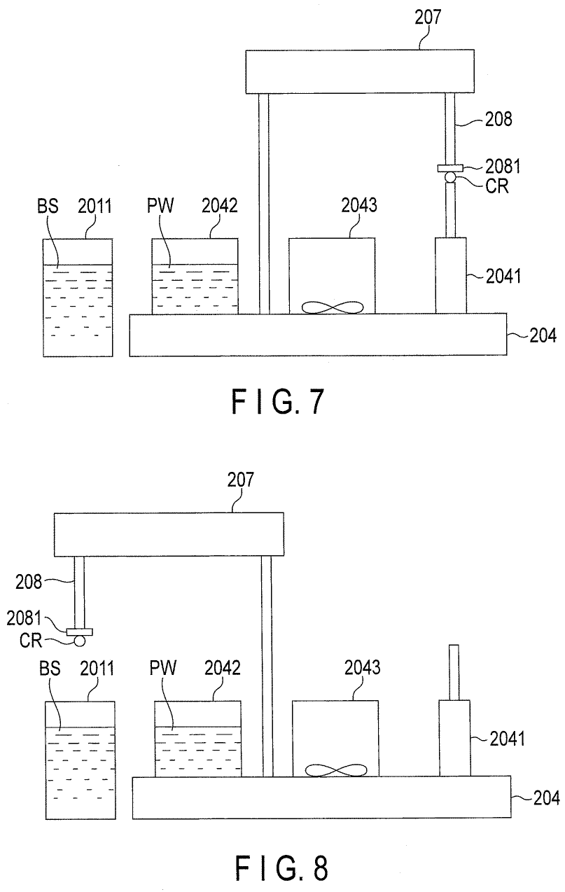

After the stirring rod arm 207 pivots, the stirring rod arm 207 moves vertically downward to let the end part 2081 of the stirring rod 208 be in contact with the concentration reagent CR, as shown in FIG. 7. At this time, a concentration reagent CR is pinpoint-dispensed to the end part 2081.

The dispensing method is not limited to the above-described one. When, for example, the reagent dispenser 2041 is movable, the control circuitry 9 may cause the reagent dispenser 2041 to be moved in a vertically upward direction with respect to the end part 2081 of the stirring rod 208.

(Step ST220)

When the concentration reagent is pinpoint-dispensed, the control circuitry 9 causes the stirring rod 208 to which the concentration reagent is adhered to be stirred in a diluent of the reaction vessel 2011. Specifically, the stirring rod arm 207 pivots the stirring rod 208 to which the concentration reagent CR is adhered at its end part 2081 to be positioned directly above the reaction vessel 2011 containing a diluent BS, as shown in FIG. 8.

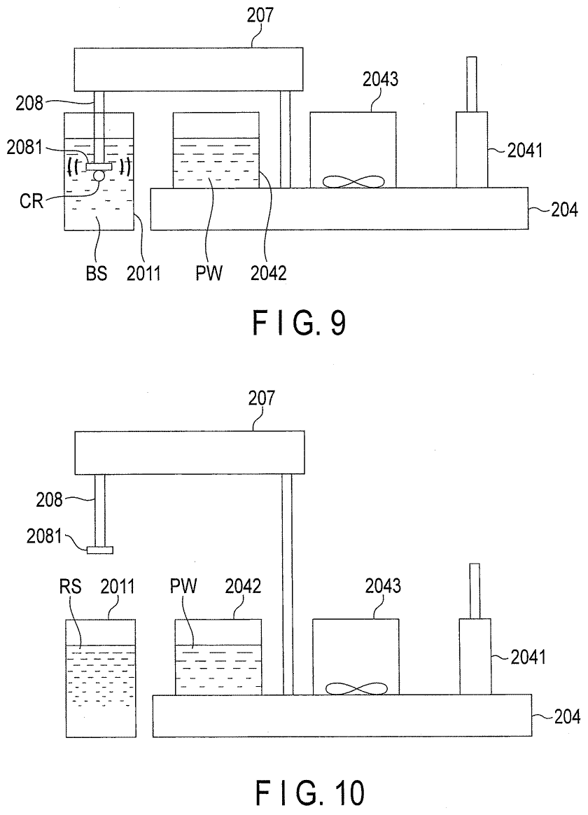

After the stirring rod arm 207 pivots, the stirring rod arm 207 moves vertically downward to let the end part 2081 to which the concentration reagent CR is adhered sink into the diluent BS, as shown in FIG. 9. The stirring rod 208 sunk in the diluent BS performs a stirring operation for a predetermined duration until the concentration reagent CR at the end part 2081 is dissolved or until the concentration reagent CR is diffused. By this stirring operation, a reagent solution RS which is a diluent of the concentration reagent CR is generated in the reaction vessel 2011. The stirring operation may be performed by at least one of, for example, vibration, sound waves, ultrasound, and rotation of any type. The stirring operation may vary according to the structure of the stirring rod 208.

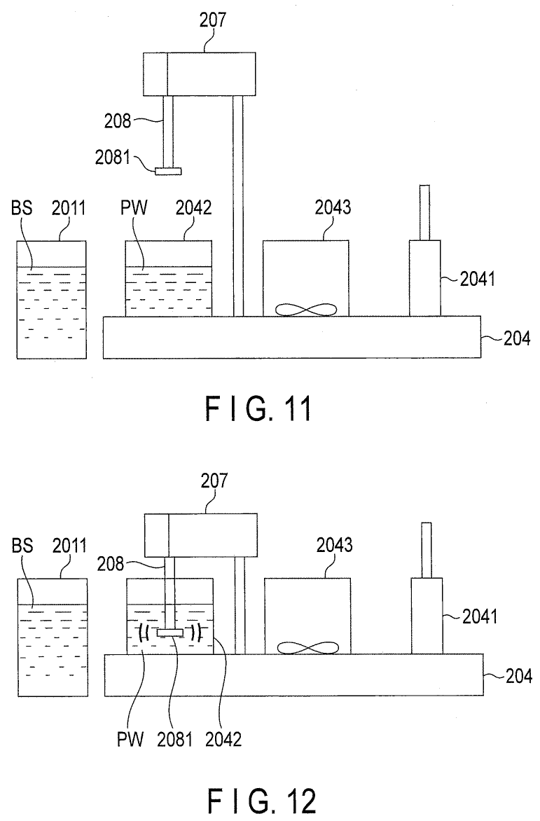

After the stirring rod arm 207 moves downward, the stirring rod arm 207 moves vertically upward so as to remove the end part 2081 from the reagent solution RS, as shown in FIG. 10. Subsequently, the stirring rod arm 207 pivots the stirring rod 208 subjected to the stirring to move directly above the washing tank 2042, as shown in FIG. 11.

(Step ST230)

After the stirring rod arm 207 pivots, the control circuitry 9 causes the stirring rod 208 subjected to the stirring to be washed. Specifically, the stirring rod arm 207 moves vertically downward to let the stirring rod 208 subjected to the stirring sink into a washing liquid PW, as shown in FIG. 12. The stirring rod 208 sunk in the washing liquid PW performs a washing operation for a predetermined duration until the reagent solution RS comes off. The washing operation may be performed by, for example, rotation, vibration, or the like of any type, similarly to the stirring operation. To enhance the washing effect, the washing tank 2042 may perform ultrasonic washing.

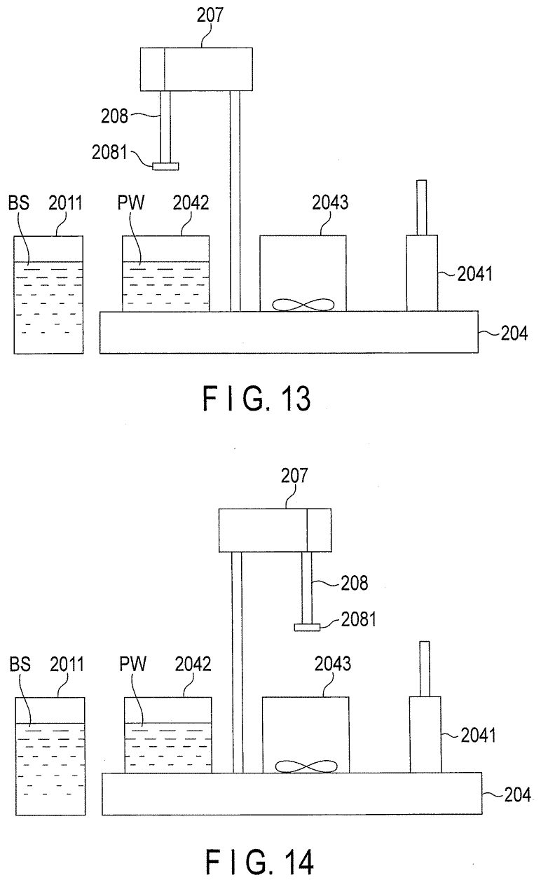

After the stirring rod arm 207 moves downward, the stirring rod arm 207 moves vertically upward to remove the stirring rod 208 from the washing liquid PW, as shown in FIG. 13. Subsequently, the stirring rod arm 207 pivots the stirring rod 208 subjected to the washing to be moved directly above the drying tank 2043, as shown in FIG. 14.

(Step ST240)

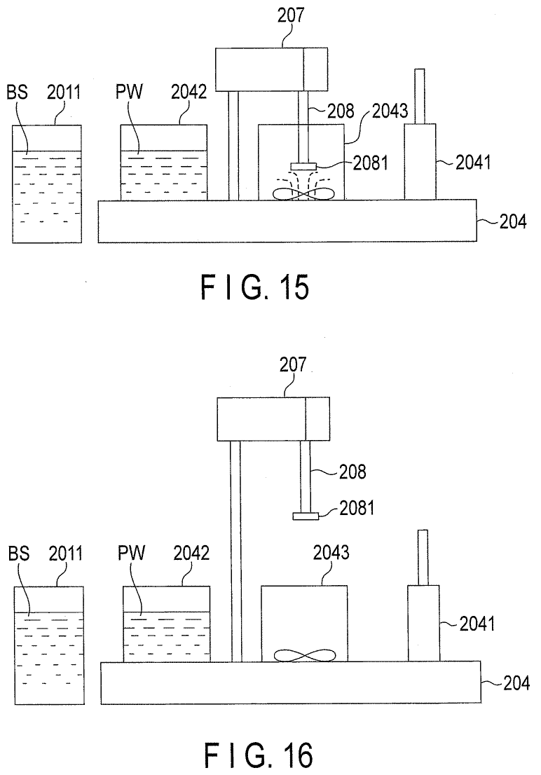

After the stirring rod arm 207 pivots, the control circuitry 9 causes the stirring rod 208 subjected to the washing to be dried. Specifically, the stirring rod arm 207 moves vertically downward to let the stirring rod 208 subjected to the washing be positioned in the drying tank 2043, as shown in FIG. 15. The stirring rod 208 positioned in the drying tank 2043 performs a drying operation for a predetermined duration until the washing water is eliminated. The drying operation may be performed by, for example, rotation, vibration, or the like of any type, similarly to the stirring and washing operations. To enhance the drying effects, the stirring rod 208 may be configured to be in contact with a material that has a high water absorbability.

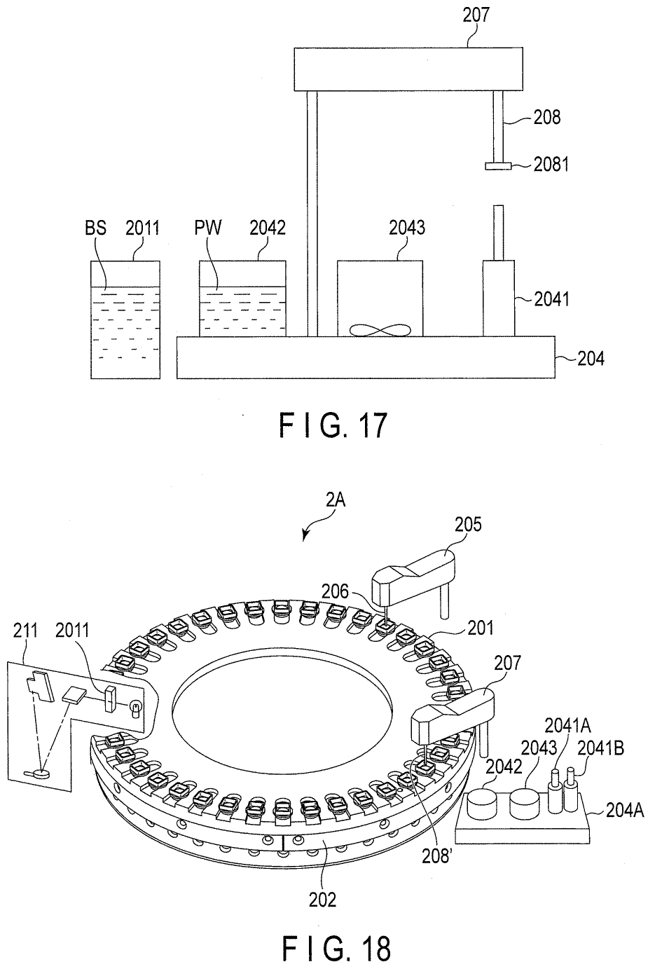

After the stirring rod arm 207 moves downward, the stirring rod arm 207 moves vertically upward so as to remove the stirring rod 208 from the drying tank 2043, as shown in FIG. 16. Subsequently, the stirring rod arm 207 rotates the stirring rod 208 subjected to the drying to be moved directly above the reagent dispenser 2041, as shown in FIG. 17.

After step ST240, the reagent solution generation process ends, and the processing advances to step ST130. The control circuitry 9 may advance to step ST130 after step ST220, and the processes at step ST130 and the steps subsequent thereto and the processes at step ST230 and the steps subsequent thereto may be performed in parallel.

(Application Example of First Embodiment)

In the first embodiment, a description has been given of the case where a concentration reagent is pinpoint-dispensed to a stirring rod and a reagent solution is generated. In the application example of the first embodiment, on the other hand, a case will be described where a specimen is pinpoint-dispensed to a stirring rod, and a mixed solution is generated.

The reagent dispenser according to the first embodiment may be replaced with, for example, a specimen dispenser for dispensing a specimen to a stirring rod. The specimen dispenser according to the application example dispenses a specimen to a stirring rod. The stirring rod to which the specimen is adhered is, for example, inserted into a reaction vessel containing a reagent solution, and stirred. Thereby, a mixed solution is generated in the reaction vessel.

As described above, the automatic analyzing apparatus according to the first embodiment and the application example of the first embodiment causes a reagent or specimen to be adhered to a stirring rod, and inserts the stirring rod to which the reagent or specimen is adhered into the vessel. In other words, the automatic analyzing apparatus includes: a dispenser for supplying at least one of a reagent and a specimen; a rod to which at least one of the reagent and the specimen supplied from the dispenser is adhered; and control circuitry for causing the rod to which at least one of the reagent and the specimen is adhered to be inserted into a liquid contained in a vessel. Therefore, the automatic analyzing apparatus, which allows, for example, a reagent or specimen to be directly dispensed to the stirring rod and thereby facilitates stirring of the reagent or specimen, circumvents the insufficiency of the subsequent stirring.

In normal dispensing and stirring, there is a possibility that the mixed solution cannot be uniquely stirred, depending on, for example, the distance between the stirring rod and the dispense target. Since an automatic analyzing apparatus is capable of performing stable stirring, it is possible to suppress variations in measurement results (errors in measurement results caused by insufficient stirring). Since the automatic analyzing apparatus is capable of suppressing errors of measurement results caused by insufficient stirring, it is possible to avoid system stoppages. In addition, since the automatic analyzing apparatus is capable of avoiding the system stoppages, an enhancement in throughput related to analysis can be expected.

### Second Embodiment

In the first embodiment, a description has been given of the case where a concentration reagent is pinpoint-dispensed to a stirring rod and a reagent solution is generated. In the application example of the first embodiment, a case has been described where a specimen is pinpoint-dispensed to a stirring rod, and a mixed solution is generated. In the second embodiment, on the other hand, a case will be described where a concentration reagent and a specimen are pinpoint-dispensed to a stirring rod, and a mixed solution is generated.

FIG. 18 is a perspective view illustrating a configuration of an analysis mechanism according to a second embodiment. As shown in FIG. 18, for example, the analysis mechanism 2A according to the first embodiment includes a reaction disk 201, a thermostatic portion 202, and a pinpoint dispense unit 204A.

The pinpoint dispense unit 204A keeps cold a plurality of reagent vessels (not illustrated) that contain a concentration reagent and the like. In addition, the pinpoint dispense unit 204A stores a plurality of specimen vessels (not illustrated) that contain a specimen for which a measurement request has been made. The pinpoint dispense unit 204A includes a reagent dispenser 2041A, a specimen dispenser 2041B, a washing tank 2042, and a drying tank 2043.

The reagent dispenser 2041A dispenses a concentration reagent to a stirring rod 208′ (to be described later). In the present embodiment, it is assumed that the reagent dispenser 2041A corresponds to a needle dispenser, and supplies a concentration reagent in a vertically upward direction.

The specimen dispenser 2041B dispenses a specimen to the stirring rod 208′. The configuration of the specimen dispenser 2041B is substantially the same as the reagent dispenser 2041. In the present embodiment, it is assumed that the specimen dispenser 2041B corresponds to a needle dispenser, and supplies a specimen in a vertically upward direction. The “specimen dispenser” in the present embodiment, which supplies a specimen, may be simply referred to as a “dispenser”.

The analysis mechanism 2A shown in FIG. 2 includes a diluent dispense arm 205, a diluent dispense probe 206, a stirring rod arm 207, a stirring rod 208′, and a photometry unit 211. The stirring rod arm 207 holds a stirring rod 208′ at one end.

As the stirring rod arm 207 pivots, the stirring rod 208′ pivots along an arc-like pivot track. On this pivot track, an opening of the reaction vessel 2011 held by the reaction disk 201, an opening of the washing tank 2042, an opening of the drying tank 2043, and an approximate center between an end of the needle of the reagent dispenser 2041A and an end of the needle of the specimen dispenser 2041B are positioned. In the second embodiment, they are respectively referred to as a “reagent solution generation position”, a “washing position”, a “drying position”, and a “pinpoint dispense position”.

The stirring rod 208′ moves between the reagent solution generation position and the pinpoint dispense position under the control of the control circuitry 9. The stirring rod 208′ which has moved to the pinpoint dispense position pinpoint-dispenses the concentration reagent supplied from the reagent dispenser 2041A and the specimen supplied from the specimen dispenser 2041B. The stirring rod 208′ which has moved to the reagent solution generation position and to which the concentration reagent and the specimen have been pinpoint-dispensed is inserted into a diluent contained in the reaction vessel 2011 and stirred. Thereby, a mixed solution is generated in the reaction vessel 2011. In the present embodiment, a “stirring rod”, to which a concentration reagent and a specimen are pinpoint-dispensed, may be simply referred to as a “rod”.

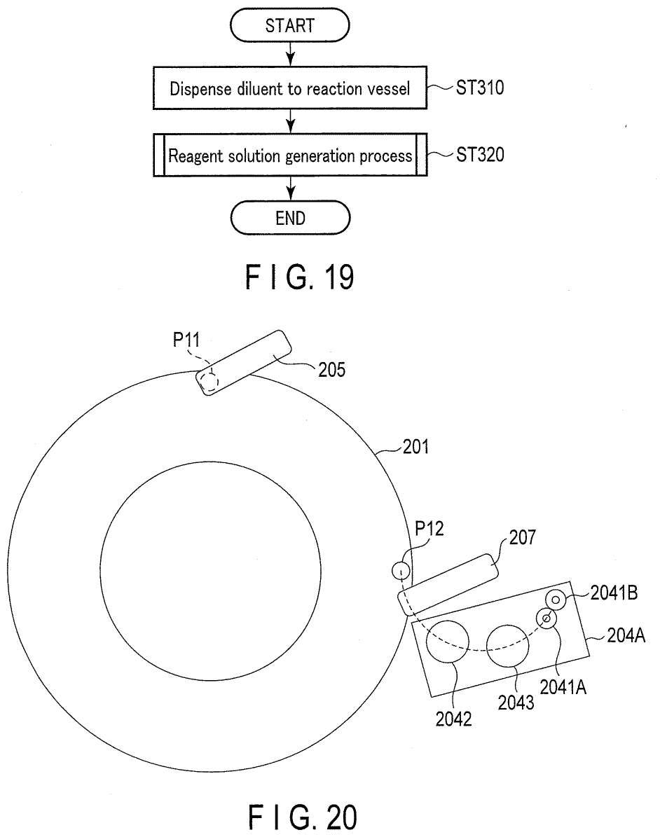

FIG. 19 is a flowchart illustrating an operation of the analysis mechanism according to the second embodiment. Upon activation of the automatic analyzing apparatus 1, for example, the control circuitry 9 reads a control program stored in the storage circuitry 8, and executes a system control function 91. Through the system control function 91, the control circuitry 9 executes a process related to a dispense function during activation of the automatic analyzing apparatus 1.

The concrete operations of the flowchart of FIG. 19 will be described with reference to the schematic view of FIG. 20. FIG. 20 is a schematic view of the analysis mechanism according to the second embodiment as viewed from above.

(Step ST310)

The control circuitry 9 causes a diluent to be dispensed to the reaction vessel 2011. Specifically, the reaction disk 201 pivots a vacant reaction vessel 2011 to be moved to a diluent dispense position (position P11) in advance. The diluent dispense probe 206 included in the diluent dispense arm 205 aspirates the diluent and provides the aspirated diluent to the vacant reaction vessel 2011 at the diluent dispense position. After the diluent has been dispensed, the reaction disk 201 pivots the reaction vessel 2011 to be moved from a position P11 to a mixed solution generation position (position P12).

(Step ST320)

After the operation at step ST310, the control circuitry 9 executes a mixed solution generation process, thereby generating a mixed solution. The mixed solution generation process will be described later.

After the mixed solution is generated, the processing ends. The control circuitry 9 may, for example, repeatedly perform the operations from step ST310 to step ST320, for example, with respect to each of the specimens held by the pinpoint dispense unit 204A.

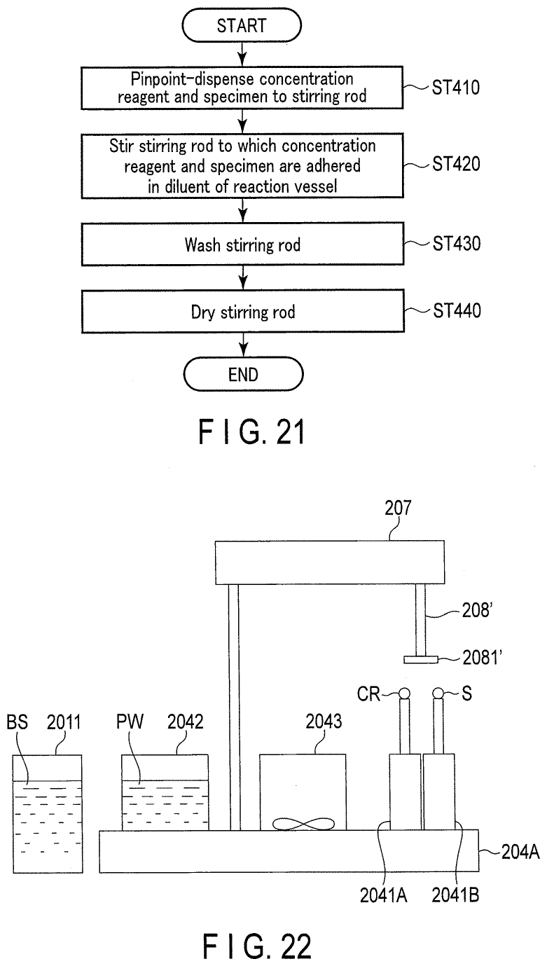

FIG. 21 is a flowchart illustrating an operation of the pinpoint dispense unit according to the second embodiment. In the flowchart of FIG. 21, step ST410 is executed after step ST310.

The concrete operations of the flowchart of FIG. 21 will be described with reference to the schematic views of FIGS. 22 to 26. FIGS. 22 to 26 are schematic diagrams illustrating operations of a pinpoint dispense unit according to the second embodiment.

(Step ST410)

The control circuitry 9 causes a concentration reagent and a specimen to be pinpoint-dispensed to the stirring rod 208′. Specifically, the stirring rod arm 207 pivots the stirring rod 208′ to be positioned directly above the reagent dispenser 2041A and the specimen dispenser 2041B, as shown in FIG. 22. At this time, a concentration reagent CR is supplied at an end of the needle disposed in the reagent dispenser 2041A, and a specimen S is supplied at an end part of the needle disposed at the specimen dispenser 2041B.

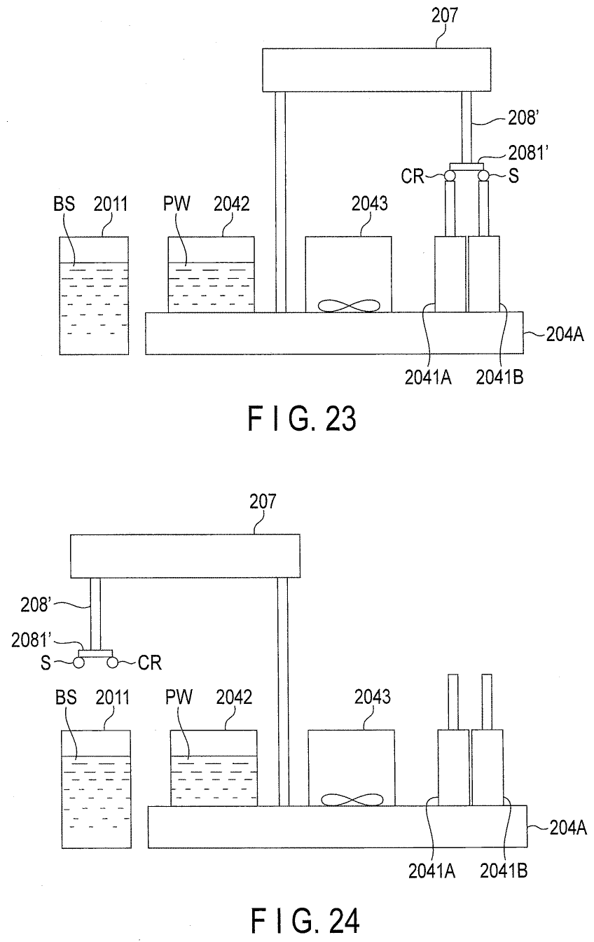

After the stirring rod arm 207 pivots, the stirring rod arm 207 moves vertically downward to let the end part 2081′ of the stirring rod 208′ be in contact with the concentration reagent CR and the specimen S, as shown in FIG. 23. At this time, a concentration reagent CR and a specimen S are pinpoint-dispensed to the end part 2081′. The dispensing method is not limited to the above-described one. When, for example, the reagent dispenser 2041A and the specimen dispenser 2041B are movable, the control circuitry 9 may cause the reagent dispenser 2041A and the specimen dispenser 2041B to be moved in a vertically upward direction with respect to the end part 2081′ of the stirring rod 208′.

(Step ST420)

When the concentration reagent and the specimen are pinpoint-dispensed, the control circuitry 9 causes the stirring rod 208′ to which the concentration reagent and the specimen are adhered to be stirred in a diluent of the reaction vessel 2011. Specifically, the stirring rod arm 207 pivots the stirring rod 208′ to which the concentration reagent CR and the specimen S are adhered at its end part 2081′ to be positioned directly above the reaction vessel 2011 containing the diluent BS, as shown in FIG. 24.

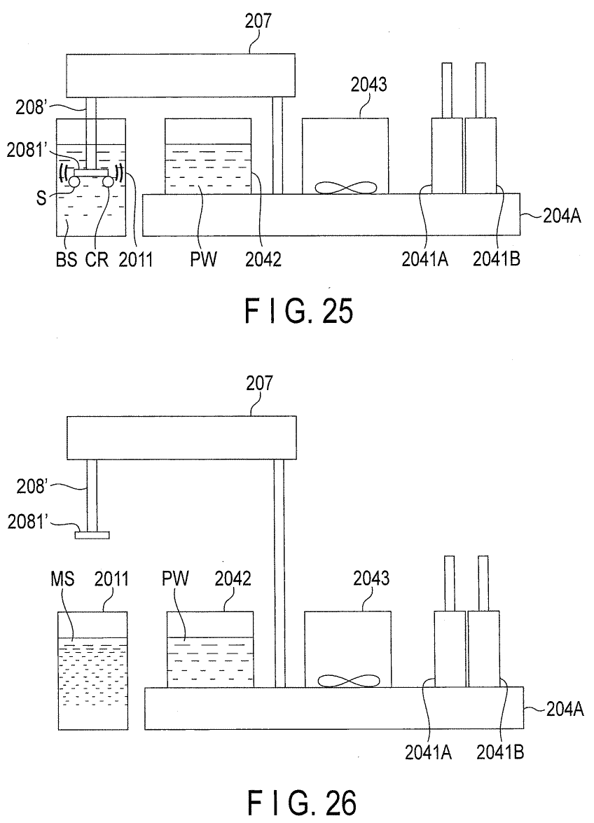

After the stirring rod arm 207 pivots, the stirring rod arm 207 moves vertically downward to let the end part 2081′ to which the concentration reagent CR and the specimen S are adhered sink into the diluent BS, as shown in FIG. 25. The stirring rod 208′ sunk in the diluent BS performs a stirring operation for a predetermined duration until the concentration reagent CR and the specimen S at the end part 2081′ are dissolved or until the concentration reagent CR and the specimen S are diffused. By this stirring operation, a mixed solution MS which is a diluent of the concentration reagent CR and further includes a specimen S is generated in the reaction vessel 2011. The stirring operation may be performed by, for example, rotation, vibration, or the like of any type.

After the stirring rod arm 207 moves downward, the stirring rod arm 207 moves vertically upward to remove the end part 2081′ from the mixed solution MS, as shown in FIG. 26. Subsequently, the stirring rod arm 207 pivots the stirring rod 208′ subjected to the stirring to be moved directly above the washing tank 2042.

Since the processes at steps ST430 and ST440 are substantially the same as those at steps ST230 and ST240, descriptions thereof will be omitted. After step ST440, the mixed solution generation process ends.

As described above, the automatic analyzing apparatus according to the second embodiment causes a reagent and a specimen to be adhered to a stirring rod, and inserts the stirring rod to which the reagent and the specimen are adhered into the vessel. Therefore, the automatic analyzing apparatus, which allows a reagent and a specimen to be directly dispensed to the stirring rod and thereby facilitates stirring of the reagent and the specimen, circumvents the insufficiency of the subsequent stirring.

Since the automatic analyzing apparatus is capable of generating a mixed solution in a single operation (e.g., in a single cycle) for a diluent, it is possible to reduce the time required for measurement preparations.

### Third Embodiment

In the first embodiment, the application example of the first embodiment, and the second embodiment, a case has been described where a reagent solution or a mixed solution is generated in the reaction vessel. In the third embodiment, on the other hand, a case will be described where a reagent solution is generated in a holding vessel provided separately.

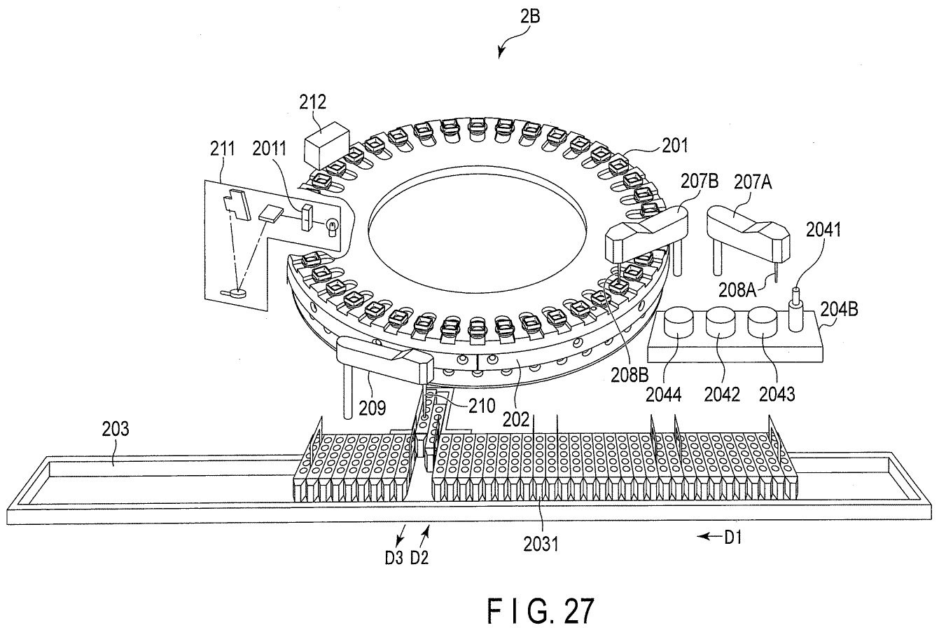

FIG. 27 is a perspective view illustrating configuration of an analysis mechanism according to a third embodiment. As shown in FIG. 27, for example, the analysis mechanism 2B according to the third embodiment includes a reaction disk 201, a thermostatic portion 202, a rack sampler 203, and a pinpoint dispense unit 204B.

The pinpoint dispense unit 204B keeps cold a plurality of reagent vessels (not illustrated) that contain a concentration reagent and the like. In addition, the pinpoint dispense unit 204B stores a plurality of specimen vessels (not illustrated) that contain a specimen for which a measurement request has been made. The pinpoint dispense unit 204B includes a reagent dispenser 2041A, a specimen dispenser 2041B, a washing tank 2042, a drying tank 2043, and a holding vessel 2044.

The holding vessel 2044 is a vessel for generating a reagent solution. In the holding vessel 2044, a diluent is contained in advance, and a reagent solution is generated by stirring a concentration reagent in the diluent. The size of the holding vessel 2044 may vary according to the amount of the reagent solution to be generated. There may be a plurality of holding vessels 2044, which may be selectively used according to the type of the reagent solution.

The diluent may be obtained by causing the reagent dispense probe 208B to provide purified water, or causing the reagent dispense probe 208B to aspirate a diluent such as purified water dispensed to the reaction vessel 2011 in advance and to provide the aspirated diluent to the holding vessel 2044.

In the pinpoint dispense unit 204B, a mechanism for washing the holding vessel 2044 or a mechanism for exchanging a plurality of holding vessels 2044 may be separately provided.

The analysis mechanism 2B shown in FIG. 27 includes a stirring rod arm 207A (also referred to as a holding mechanism), a stirring rod 208A, a reagent dispense arm 207B, a reagent dispense probe 208B, a sample dispense arm 209, a sample dispense probe 210, a photometry unit 211, and a stirring unit 212.

The stirring rod arm 207A is disposed in the vicinity of the pinpoint dispense unit 204B. The stirring rod arm 207A is disposed, by the driving mechanism 4, to be movable vertically upward and downward, and be horizontally pivotable. The stirring rod arm 207A holds a stirring rod 208A at one end.

As the stirring rod arm 207A pivots, the stirring rod 208A pivots along an arc-like pivot track. On this pivot track, an opening of the holding vessel 2044, an opening of the washing tank 2042, an opening of the drying tank 2043, and an end of the needle of the reagent dispenser 2041 are positioned. In the third embodiment, they are respectively referred to as a “reagent solution generation position”, a “washing position”, a “drying position”, and a “pinpoint dispense position”.

The stirring rod 208A moves between the reagent solution generation position and the pinpoint dispense position under the control of the control circuitry 9. The stirring rod 208A which has moved to the pinpoint dispense position pinpoint-dispenses the concentration reagent supplied from the reagent dispenser 2041. The stirring rod 208A which has moved to the reagent solution generation position and to which the concentration reagent has been pinpoint-dispensed is inserted into a diluent contained in the reaction vessel 2044 and stirred. Thereby, a diluted reagent solution is generated in the reaction vessel 2044. In the present embodiment, a “stirring rod”, to which a concentration reagent is pinpoint-dispensed, may be simply referred to as a “rod”.

The reagent dispense arm 207B is disposed in the vicinity of the reaction disk 201 and the pinpoint dispense unit 204B. The reagent dispense arm 207B is disposed, by the driving mechanism 4, to be movable vertically upward and downward, and be horizontally pivotable. The reagent dispense arm 207B holds the reagent dispense probe 208B at one end.

As the reagent dispense arm 207B pivots, the reagent dispense probe 208B pivots along an arc-like pivot track. On this pivot track, an opening of the reaction vessel 2011 held by the reaction disk 201 and an opening of the holding vessel 2044 are positioned. In the third embodiment, they are respectively referred to as a “reagent solution dispense position” and a “reagent solution generation position”.

The reagent dispense probe 208B is driven by the driving mechanism 4, and moves upward and downward at the reagent solution dispense position and the reagent solution generation position. Under the control of the control circuitry 9, the reagent dispense probe 208B aspirates a reagent solution from the holding vessel 2044 positioned directly below the reagent solution generation position. Under the control of the control circuitry 9, the reagent dispense probe 208B provides the aspirated reagent solution to the reaction vessel 2011 positioned directly below the reagent solution dispense position.

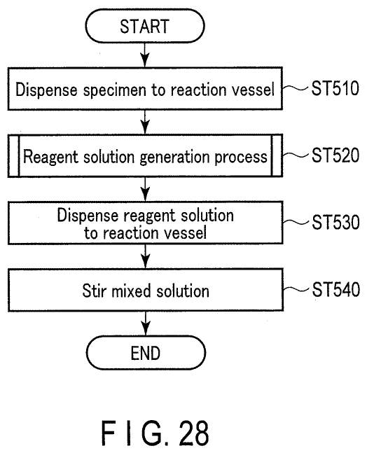

FIG. 28 is a flowchart illustrating an operation of the analysis mechanism according to the third embodiment. Upon activation of the automatic analyzing apparatus 1, the control circuitry 9 reads a control program stored in the storage circuitry 8, and executes a system control function 91. Through the system control function 91, the control circuitry 9 executes a process related to a dispense function during activation of the automatic analyzing apparatus 1.

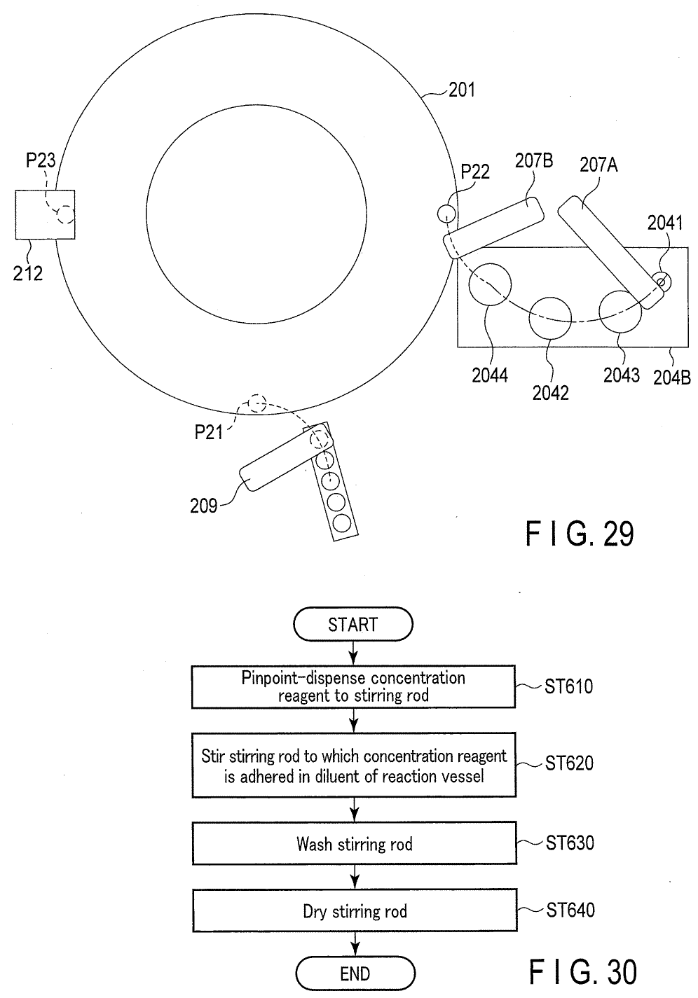

The concrete operations of the flowchart of FIG. 28 will be described with reference to the schematic view of FIG. 29. FIG. 29 is a schematic view of the analysis mechanism according to the third embodiment as viewed from above.

(Step ST510)

The control circuitry 9 causes a specimen to be dispensed to the reaction vessel 2011. Specifically, the sample dispense probe 210 aspirates a specimen from the specimen vessel, and provides the aspirated specimen to the reaction vessel 2011 at the sample provide position (position P21). After the specimen is provided, the reaction disk 201 pivots the reaction vessel 2011 to be moved from the position P21 to a reagent solution dispense position (position P22).

(Step ST520)

After the operation at step ST510, the control circuitry 9 executes a reagent solution generation process, thereby generating a reagent solution in the holding vessel 2044. The reagent solution generation process will be described later. The reagent solution generation process need not be performed every time.

(Step ST530)

After the operation at step ST520, the control circuitry 9 causes a reagent solution to be dispensed to the reaction vessel 2011. Specifically, the reagent dispense probe 208B aspirates a reagent solution from the holding vessel 2044, and provides the aspirated reagent solution to the reaction vessel 2011 at the reagent solution dispense position (position P22). After the reagent solution is provided, the reaction disk 201 pivots the reaction vessel 2011 to be moved to a mixed solution stirring position (position P23).

(Step ST540)

After the operation at step ST530, the control circuitry 9 causes a mixed solution of a specimen and a reagent solution to be stirred. Specifically, the stirring unit 212 stirs a mixed solution contained in the reaction vessel 2011 at the mixed solution stirring position (position P23) using a stirring rod.

After step ST540, the processing ends. The control circuitry 9 may, for example, repeatedly perform the operations from step ST510 to step ST540, for example, with respect to each of the specimen vessels held by the rack sampler 203.

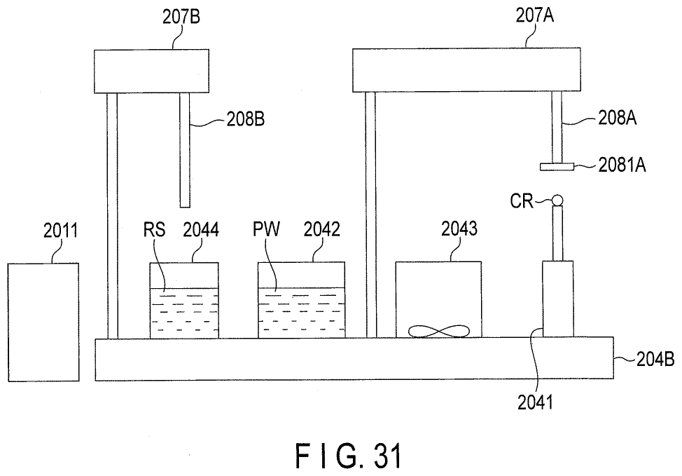

FIG. 30 is a flowchart illustrating an operation of a pinpoint dispense unit according to the third embodiment. In the flowchart of FIG. 30, the reagent solution generation process at step ST520 is included, and step ST610 is executed after step ST510.

The concrete operations of the flowchart of FIG. 30 will be described with reference to the schematic view of FIG. 31. FIG. 31 is a schematic diagram illustrating an operation of a pinpoint dispense unit according to the third embodiment.

(Step ST610)

The control circuitry 9 causes a concentration reagent to be pinpoint-dispensed to the stirring rod 208A. Specifically, the stirring rod arm 207A pivots the stirring rod 208A to be positioned directly above the reagent dispenser 2041, as shown in FIG. 31. At this time, a concentration reagent CR is supplied at an end of the needle disposed at the reagent dispenser 2041.

After the stirring rod arm 207A pivots, the stirring rod arm 207A moves vertically downward to let the end part 2081A of the stirring rod 208A be in contact with the concentration reagent CR. At this time, a concentration reagent CR is pinpoint-dispensed to the end part 2081A.

The dispensing method is not limited to the above-described one. When, for example, the reagent dispenser 2041 is movable, the control circuitry 9 may cause the reagent dispenser 2041 to be moved in a vertically upward direction with respect to the end part 2081A of the stirring rod 208A.

(Step ST620)

When the concentration reagent is pinpoint-dispensed, the control circuitry 9 causes the stirring rod 208A to which the concentration reagent is adhered to be stirred in a diluent of the reaction vessel 2044. Specifically, the stirring rod arm 207A pivots the stirring rod 208A to which the concentration reagent CR is adhered at its end part 2081A to be positioned directly above the holding vessel 2044 containing a diluent. At this time, the reagent dispense arm 207B is held at a position where interference is not caused with the stirring rod arm 207A. The position where interference is not caused refers to, for example, a position where the reagent dispense probe 208B of the reagent dispense arm 207B comes directly above the reaction vessel 2011.

After the stirring rod arm 207A pivots, the stirring rod arm 207A moves vertically downward to let the end part 2081A to which the concentration reagent CR is adhered sink into the diluent. The stirring rod 208A sunk in the diluent performs a stirring operation for a predetermined duration until the concentration reagent CR at the end part 2081A is dissolved or until the concentration reagent CR is diffused. By this stirring operation, a reagent solution RS obtained by diluting the concentration reagent CR is generated in the holding vessel 2044. The stirring operation may be performed by at least one of, for example, vibration, sound waves, ultrasound, and rotation of any type. The stirring operation may vary according to the structure of the stirring rod 208A.

After the stirring rod arm 207A moves downward, the stirring rod arm 207A moves vertically upward so as to remove the end part 2081A from the reagent solution RS. Subsequently, the stirring rod arm 207A pivots the stirring rod 208A subjected to the stirring to move directly above the washing tank 2042.

Since the processes at steps ST630 and ST640 are substantially the same as those at steps ST230 and ST240, descriptions thereof will be omitted. After step ST640, the reagent solution generation process ends. The control circuitry 9 may advance to step ST530 after step ST620, and the processes at step ST530 and the steps subsequent thereto and the processes at step ST630 and the steps subsequent thereto may be performed in parallel.

As described above, the automatic analyzing apparatus according to the third embodiment causes a reagent to be adhered to a stirring rod, and inserts the stirring rod to which the reagent is adhered into a vessel different from the reaction vessel. Thus, the automatic analyzing apparatus, which allows a reagent to be directly dispensed to the stirring rod and thereby facilitates stirring of the reagent, circumvents the insufficiency of the subsequent stirring. In addition, the pinpoint dispense unit of the automatic analyzing apparatus, which is capable of generating a specimen solution in a vessel different from the reaction vessel, can be applied to the conventional automatic analyzing apparatus.

According to at least one of the above-described embodiments, it is possible to circumvent the insufficient stirring caused by making the target to be dispensed in a micro amount.

The term “processor” used in the above description means, for example, a central processing unit (CPU), a graphics processing unit (GPU), or circuitry such as an application-specific integrated circuit (ASIC), or a programmable logic device (e.g., a simple programmable logic device (SPLD), a complex programmable logic device (CPLD), or a field programmable gate array (FPGA)). The processor reads and executes programs stored in storage circuitry to execute the respective functions. The programs may be directly incorporated into circuitry of the processor, instead of being stored in the storage circuitry. In this case, the processor reads the programs incorporated in its circuitry and executes them to implement the respective functions. Each processor of the above embodiments is not necessarily configured as a single circuit, and may be configured by a combination of a plurality of independent circuits to implement its functions. Furthermore, a plurality of components in the above embodiment may be integrated into a single processor to implement their functions.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An automatic analyzing apparatus comprising:
a dispenser for supplying at least one of a reagent and a specimen;
a rod to which at least one of the reagent and the specimen supplied from the dispenser is adhered; and
control circuitry which inserts the rod to which said at least one of the reagent and the specimen is adhered into a liquid contained in a vessel.

2. The automatic analyzing apparatus according to claim 1, further comprising:
a holding mechanism configured to hold the rod, wherein
the control circuitry causes the rod to which said at least one of the reagent and the specimen is adhered to be inserted into the liquid contained in the vessel by driving the holding mechanism.

3. The automatic analyzing apparatus according to claim 2, wherein
the control circuitry causes said at least one of the reagent and the specimen supplied from the dispenser to be adhered to the rod by driving the holding mechanism.

4. The automatic analyzing apparatus according to claim 1, wherein
the control circuitry causes said at least one of the reagent and the specimen to be adhered to the rod by driving the dispenser.

5. The automatic analyzing apparatus according to claim 1, wherein
the control circuitry causes the rod to be stirred in the liquid contained in the vessel.

6. The automatic analyzing apparatus according to claim 5, wherein
when the reagent is adhered to the rod and a diluent is contained in the vessel,
the control circuitry causes the rod to which the reagent is adhered to be stirred in the diluent to generate a reagent solution.

7. The automatic analyzing apparatus according to claim 5, wherein
when the specimen is adhered to the rod and a reagent solution is contained in the vessel,
the control circuitry causes the rod to which the specimen is adhered to be stirred in the reagent solution to generate a mixed solution.

8. The automatic analyzing apparatus according to claim 5, wherein
when the reagent and the specimen are adhered to the rod and a diluent is contained in the vessel,
the control circuitry causes the rod to which the reagent and the specimen are adhered to be stirred in the diluent to generate a mixed solution.

9. The automatic analyzing apparatus according to claim 5, wherein
the stirring is caused by at least one of vibration, sound waves, ultrasound, and rotation.

10. The automatic analyzing apparatus according to claim 5, further comprising:
a washing tank which washes the rod subjected to the stirring, wherein
the control circuitry causes the rod subjected to the stirring to be washed in the washing tank.

11. The automatic analyzing apparatus according to claim 10, further comprising:
a drying tank which dries the rod subjected to the washing, wherein
the control circuitry causes the rod subjected to the washing to be dried in the drying tank.
